(19) United States
(12) Patent Application Publication
(10) Pub. No.: US 2022/0242236 A1
(43) Pub. Date: Aug. 4, 2022

(54) IN-VEHICLE DEVICE, IN-VEHICLE DEVICE CONTROL METHOD, AND IN-VEHICLE SYSTEM

(71) Applicant: Panasonic Intellectual Property Management Co., Ltd., Osaka (JP)

(72) Inventors: Ginga EGUCHI, KANAGAWA KEN (JP); Takayuki SUZUKI, KANAGAWA KEN (JP); Akitoshi YAMASHITA, KANAGAWA KEN (JP)

(73) Assignee: Panasonic Intellectual Property Management Co., Ltd., Osaka (JP)

(21) Appl. No.: 17/588,802

(22) Filed: Jan. 31, 2022

(30) Foreign Application Priority Data
Feb. 4, 2021 (JP) 2021-016880

(51) Int. Cl. B60K 35/00

(52) U.S. Cl. CPC B60K 35/00; B60K 2370/1529; B60K 2370/785; B60K 2370/186; B60K 2370/176

(57) ABSTRACT

An in-vehicle device includes a memory, and a hardware processor coupled to the memory. The hardware processor is configured to: receive a second signal transmitted from a target apparatus when an input of a first signal to the target apparatus has been received, the second signal being related to the first signal; and display, when the second signal has been received, a first image including one or more display elements related to a state of the target apparatus on a display area predetermined in a part of a front visual field of a driver of a vehicle.

### CROSS-REFERENCE TO RELATED APPLICATIONS

This application is based upon and claims the benefit of priority from Japanese Patent Application No. 2021-016880, filed on Feb. 4, 2021, the entire contents of which are incorporated herein by reference.

### FIELD

The present disclosure relates to an in-vehicle device, an in-vehicle device control method, and an in-vehicle system.

### BACKGROUND

There is disclosed a technique of displaying, in a vehicle, a setting state, options of functions, and the like of an electronic apparatus provided in the vehicle. A user performs an operation while visually recognizing a target electronic apparatus, so as to input an instruction regarding display contents, functions, and the like. Moreover, there is disclosed a technique of preventing a gaze at a display of an electronic apparatus. For example, Japanese Patent Application Laid-open No. 2013-20334 discloses a technique of switching display on a display to display on a front window when a continuous gaze at a display for a given period of time or longer is detected.

However, in the conventional technique, to switch or confirm the state of a target apparatus that is a target electronic apparatus, a driver needs to perform an operation while gazing at the target apparatus. Thus, in the conventional technique, it may have been difficult to prevent a gaze at a target apparatus.

The present disclosure aims at providing an in-vehicle device, an in-vehicle device control method, and an in-vehicle system capable of preventing a gaze at a target apparatus.

### SUMMARY

An in-vehicle device according to the present disclosure includes a memory, and a hardware processor coupled to the memory. The hardware processor is configured to: receive a second signal transmitted from a target apparatus when an input of a first signal to the target apparatus has been received, the second signal being related to the first signal; and display, when the second signal has been received, a first image including one or more display elements related to a state of the target apparatus on a display area predetermined in a part of a front visual field of a driver of a vehicle.

### BRIEF DESCRIPTION OF THE DRAWINGS

FIG. 1 is a diagram illustrating an example of an in-vehicle system according to an embodiment;

FIG. 2 is an example of a hardware configuration diagram;

FIG. 3 is a schematic view illustrating an example of a vehicle interior of a vehicle;

FIG. 4 is a schematic view illustrating a use example of a head up display (HUD) device;

FIG. 5A is an explanatory diagram illustrating an example of a display image;

FIG. 5B is an explanatory diagram illustrating an example of a display image;

FIG. 5C is an explanatory diagram illustrating an example of a display image;

FIG. 6A is an explanatory diagram illustrating an example of a display image;

FIG. 6B is an explanatory diagram illustrating an example of a display image;

FIG. 6C is an explanatory diagram illustrating an example of a display image;

FIG. 7A is a schematic view illustrating an example of a first image;

FIG. 7B is a schematic view illustrating an example of a first image;

FIG. 7C is a schematic view illustrating an example of a first image;

FIG. 7D is a schematic view illustrating an example of a first image;

FIG. 8A is an explanatory diagram illustrating an example of a display image;

FIG. 8B is an explanatory diagram illustrating an example of a display image;

FIG. 8C is an explanatory diagram illustrating an example of a display image; and

FIG. 8D is an explanatory diagram illustrating an example of a display image;

FIG. 9 is a flowchart illustrating an example of information processing performed by an electronic apparatus according to the embodiment; and

FIG. 10 is a flowchart illustrating an example of information processing performed by an in-vehicle device according to the embodiment.

### DETAILED DESCRIPTION

The following will describe an embodiment of an in-vehicle device, an in-vehicle device control method, and an in-vehicle system of the disclosure with reference to the enclosed drawings.

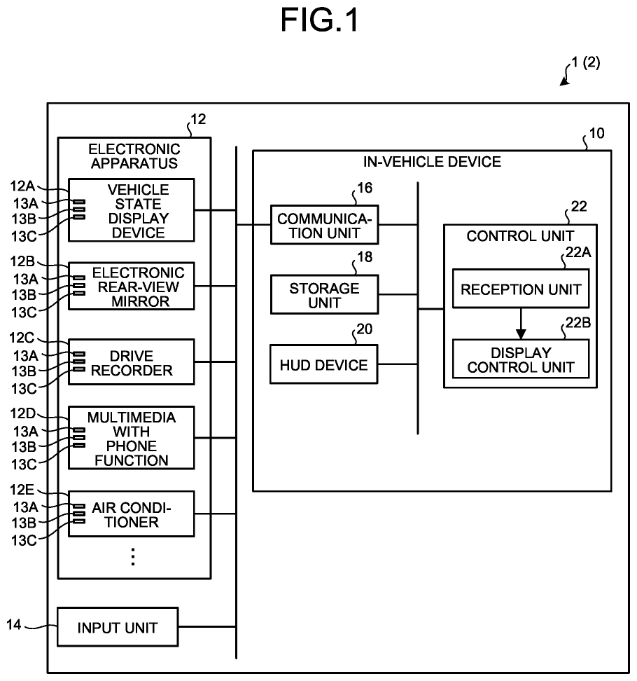

FIG. 1 is a diagram illustrating an example of an in-vehicle system 1 according to the embodiment. The in-vehicle system 1 is a system provided in a vehicle 2, for example.

The in-vehicle system 1 includes an in-vehicle device 10, an electronic apparatus 12, and an input unit 14. The in-vehicle device 10, the electronic apparatus 12, and the input unit 14 are communicably connected to one another.

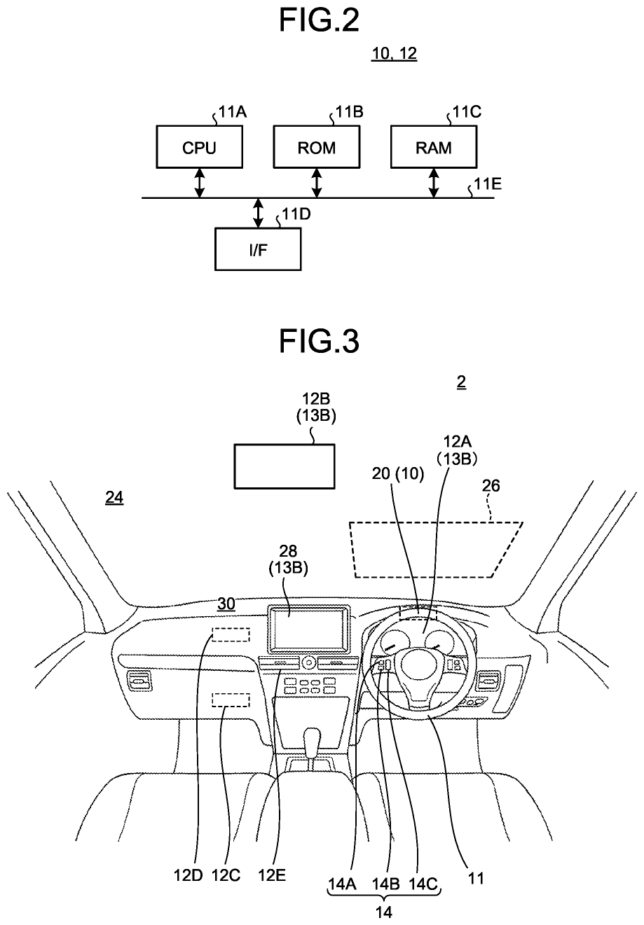

FIG. 2 is an example of a hardware configuration diagram of the in-vehicle device 10 and the electronic apparatus 12.

The in-vehicle device 10 and the electronic apparatus 12 have a hardware configuration using a normal computer, in which a central processing unit (CPU, an example of a hardware processor) 11A, a read-only memory (ROM) 11B, a random-access memory (RAM) 11C, an interface (I/F) 11D, and the like are connected mutually by a bus 11E.

The CPU 11A is an arithmetic unit that controls the in-vehicle device 10 and the electronic apparatus 12 of the embodiment. The ROM 11B stores computer programs and the like that achieve various kinds of processing by the CPU 11A. The RAM 11C stores data necessary for various kinds of processing by the CPU 11A. The I/F 11D is an interface for transmitting and receiving data.

A computer program for executing information processing performed by the in-vehicle device 10 and the electronic apparatus 12 of the embodiment is preliminary installed and provided in the ROM 11B or the like. Note that a computer program executed by the in-vehicle device 10 and the electronic apparatus 12 of the embodiment may be recorded and provided in a format installable or executable in the in-vehicle device 10 and the electronic apparatus 12 in a computer-readable recording medium such as a compact disc read only memory (CD-ROM), a flexible disk (FD), a compact disc recordable (CD-R), or a digital versatile disc (DVD).

Returning to FIG. 1, the description is continued.

The in-vehicle system 1 includes one or more electronic apparatuses 12. The embodiment exemplifies a form where the in-vehicle system 1 includes a plurality of electronic apparatuses 12.

The electronic apparatus 12 is an example of a target apparatus. The target apparatus is the electronic apparatus 12 to be operated or confirmed by a driver as a user. The electronic apparatus 12 includes a control unit 13A, a display unit 13B, and an input unit 13C. The control unit 13A, the display unit 13B, and the input unit 13C are communicably connected to one another. The control unit 13A executes a computer program preliminarily installed in the control unit 13A to perform information processing such as control processing on predetermined mechanisms. The display unit 13B displays various kinds of information. The input unit 13C receives an operation instruction from a user.

In the embodiment, the control unit 13A of the electronic apparatus 12 controls various mechanisms provided in the vehicle 2.

Examples of the mechanism provided in the vehicle 2 include an engine, a motor, a meter, a transmission, a brake, a lamp, a power steering, an air conditioner, an audio, a navigation, a drive recorder, an electronic rear-view mirror, a radio, outgoing and incoming phone calls, and the like, in the vehicle 2. Note that the mechanism is not limited thereto as long as it is provided in the vehicle 2 and controlled by the electronic apparatus 12.

The electronic apparatus 12 is, for example, a vehicle state display device 12A, an electronic rear-view mirror 12B, a drive recorder 12C, a multimedia 12D with phone function, an air conditioner 12E, a radio, and the like. Note that the electronic apparatus 12 is not limited thereto.

The vehicle state display device 12A is an electronic apparatus 12 that displays information related to the state of the vehicle 2. Examples of the information related to the state of the vehicle 2 include a speed, average fuel consumption, instantaneous fuel consumption, vehicle maintenance, an integrated value of traveling distance, a travelable distance, an energy remaining amount, the on/off state of a drive support function, and the like of the vehicle 2. The drive support function is, for example, a lane keeping control function, an inter-vehicle distance control function, a speed keeping control function, and the like. The function may be referred to as a mode.

For example, the control unit 13A of the vehicle state display device 12A displays information related to the state of the vehicle 2 on the display unit 13B.

Moreover, the control unit 13A of the vehicle state display device 12A transmits a function execution instruction selected by an operation instruction from a user or the like, to a corresponding mechanism. For example, it is assumed that the instruction for turning on a lane keeping control function has been selected. In this case, the control unit 13A of the vehicle state display device 12A transmits a lane keeping control function execution instruction to an electronic control unit (ECU) for executing a lane keeping function. With such processing, the lane keeping control function is turned on. Moreover, it is assumed that the instruction for turning on an inter-vehicle distance control function has been selected. In this case, the control unit 13A of the vehicle state display device 12A transmits an inter-vehicle distance control function execution instruction to the ECU for executing the inter-vehicle distance control function. With such processing, the inter-vehicle distance control function is turned on. Similarly, when the instruction for turning on a speed keeping control function has been selected, the control unit 13A of the vehicle state display device 12A transmits a speed keeping control function execution instruction to a corresponding ECU. With such processing, the speed keeping control function is turned on.

The electronic rear-view mirror 12B is the electronic apparatus 12 provided at a position of a rear-view mirror of the vehicle 2 such as a mirror for seeing rearward. The electronic rear-view mirror 12B includes, as the display unit 13B, a display where a camera image is displayed. The electronic rear-view mirror 12B may have a reflection mechanism for reflecting at least a part of incident light. The reflection mechanism is a half mirror, for example. The electronic rear-view mirror 12B has functions such as a wide angle mode, a glare proof mode, and a vehicle interior mode, for example. In a case where the wide angle mode is on, the control unit 13A of the electronic rear-view mirror 12B displays a camera image captured with a wide angle on the display unit 13B. In a case where the glare proof mode is on, the control unit 13A of the electronic rear-view mirror 12B displays a camera image with suppressed light reflection on the display unit 13B. In a case where the vehicle interior mode is on, the control unit 13A of the electronic rear-view mirror 12B displays a camera image of a vehicle interior of the vehicle 2 on the display unit 13B. In a case where the electronic rear-view mirror 12B has a glare proof mechanism for suppressing light reflection, and the glare proof mode is on, the glare proof mechanism may be set to be an on state. In a case where the glare proof mode is on in such an electronic rear-view mirror 12B, the control unit 13A of the electronic rear-view mirror 12B turns on the glare proof mechanism.

The drive recorder 12C is an electronic apparatus 12 that records the traveling state of the vehicle 2 by images. The drive recorder 12C has functions such as an event recording mode, and a continuous recording mode, for example. In a case where the event recording mode is on, the control unit 13A of the drive recorder 12C records images when an event occurs. The drive recorder 12C may include an acceleration sensor, for example, and determine, when an acceleration detected by the acceleration sensor has exceeded a threshold, that an event occurs, and record images. In a case where the continuous recording mode is on, the control unit 13A of the drive recorder records images continuously.

The multimedia 12D with phone function is a multimedia having a phone function. The multimedia 12D with phone function is, for example, a cellular phone, a smartphone, and the like. The multimedia 12D with phone function may be a handsfree device that is connected to a phone network through a cellular phone and the like.

For example, the control unit 13A of the multimedia 12D with phone function stores phone book data, and history data such as outgoing phone call history data and incoming phone call history data. The control unit 13A of the multimedia 12D with phone function displays information in accordance with an operation instruction from a user. Moreover, the multimedia 12D with phone function has functions such as an outgoing phone call function, an incoming/outgoing phone call history management function, a phone book management function, and a favorite management function, for example. In accordance with an operation instruction from a user, the control unit 13A of the multimedia 12D with phone function executes various functions such as an outgoing phone call function, an incoming/outgoing phone call history management function, a phone book management function, and a favorite management function. The favorite management function is a function for managing phone information set as favorite information by a user. The favorite management function may be referred to as a quick dial function. The phone information includes a phone number, a user name of an outgoing phone call destination, and the like.

For example, when the incoming/outgoing phone call history management function has been selected, the control unit 13A of the multimedia 12D with phone function displays, on the display unit 13B, phone information stored as an incoming/outgoing phone call history. It is assumed that the phone information has been selected by an operation instruction from a user and an instruction for an outgoing phone call has been input. In this case, the control unit 13A of the multimedia 12D with phone function calls a phone number in the selected phone information as an outgoing phone call destination.

The air conditioner 12E is an air conditioning apparatus that adjusts air temperature, humidity, and the like in the vehicle 2. The air conditioner 12E has functions such as a heating function, a cooling function, and a dehumidification function, for example. In accordance with an operation instruction from a user, the control unit 13A of the air conditioner 12E performs a control for turning on and off various functions, a control for conditioning air to a set temperature or humidity, and the like.

Each of the electronic apparatuses 12 includes the display unit 13B for displaying one or more display elements. The display element will be described later. The display unit 13B may be provided commonly for one or more electronic apparatuses 12, or may be provided for each of the electronic apparatuses 12. In the embodiment, the display unit 13B is provided at a position corresponding to each of the electronic apparatuses 12.

Moreover, each of the electronic apparatuses 12 includes the input unit 13C for receiving an operation instruction from a user. The user operates the input unit 13C so as to input various instructions to the corresponding electronic apparatus 12. The input unit 13C may be provided commonly for one or more electronic apparatuses 12, or may be provided for each of the electronic apparatuses 12. In the embodiment, the input unit 13C is provided at a position corresponding to each of the electronic apparatuses 12.

The input unit 14 receives various instruction signals to the electronic apparatus 12 from a user. The input unit 14 is provided at a position allowing a driver of the vehicle 2 to operate while visually recognizing the front visual field.

FIG. 3 is a schematic view illustrating an example of a vehicle interior of the vehicle 2.

The input unit 14 is provided at a steering wheel 11 of the vehicle 2, for example. Each electronic apparatus 12 is configured to be able to receive an operation instruction by the input unit 14.

In the embodiment, the input unit 14 receives a first signal to a target apparatus.

The first signal is an instruction signal to a target apparatus. To be more specific, the first signal is at least one of a target apparatus state switching instruction signal and a target apparatus state confirming instruction signal. The switching instruction signal is a signal for instructing switching of the state of a target apparatus. In other words, the switching instruction signal is a signal input when a user desires to switch the state of a target apparatus. The confirming instruction signal is a signal for instructing confirmation of the state of a target apparatus. In other words, the confirming instruction signal is a signal input when a user desires to confirm the state of a target apparatus.

The state of a target apparatus includes setting contents and display contents of a target apparatus, and the like. Examples of the setting contents of a target apparatus include functions of the electronic apparatus 12 as a target apparatus, setting values for each function of the electronic apparatus 12, the on/off state of each function of the electronic apparatus 12, and the like. Examples of the display contents of a target apparatus include display contents currently displayed on the display unit 13B of the electronic apparatus 12 as a target apparatus, information that can be displayed by the electronic apparatus 12, and the like.

A driver as a user operates the input unit 14 to switch or confirm the state of the electronic apparatus 12. As described above, the input unit 14 is provided at a position allowing a driver of the vehicle 2 to operate while visually recognizing the front visual field. Thus, the driver is able to operate the input unit 14 while visually recognizing the front visual field. With an operation on the input unit 14, the electronic apparatus 12 as a target apparatus receives the first signal. Note that the input unit 14 may output the first signal also to the in-vehicle device 10.

The embodiment exemplifies a case where the input unit 14 is formed by a plurality of switches 14A, 14B, and 14C.

The embodiment exemplifies a case where the switch 14A is a switch for receiving the first signal.

In the switch 14A, operation patterns corresponding to each of the electronic apparatuses 12 are defined preliminarily. When an operation with a certain operation pattern has been performed, the switch 14A receives the first signal to the electronic apparatus 12 corresponding to such an operation pattern. The operation pattern is formed by the combination of a double click, a triple click, an operation direction, and the like, for example. Note that the switch 14A may be provided to correspond to each of the electronic apparatuses 12.

For example, when an operation with a predetermined operation pattern has been performed, the switch 14A outputs the first signal to the electronic apparatus 12 corresponding to such an operation pattern. Thus, the first signal is output to a target apparatus to be operated or confirmed by a user among the electronic apparatuses 12.

The switch 14B and the switch 14C are switches operated to perform various instructions to the electronic apparatuses 12. For example, the switch 14B and the switch 14C are switches for instructing the electronic apparatus 12 targeted by an operation instruction of the switch 14A to execute various functions. The operation signals of the switch 14B and the switch 14C are output to the electronic apparatus 12 and the in-vehicle device 10.

Note that the input unit 14 is not limited to the form including three switches 14A, 14B, and 14C. For example, the input unit 14 may be formed by one switch, two switches, or four or more switches. For each of switches, the kind of signal to be output when the switch is operated may be predetermined.

Moreover, the input unit 14 operated by a driver as a user may be provided at a position allowing the driver of the vehicle 2 to operate while visually recognizing the front visual fields, without limiting to the form in which the input unit 14 is provided at the steering wheel 11. Furthermore, the input unit 14 is not limited to a member operated physically such as a switch, and may be a system that detects actions, sight line directions, and the like of a driver. In this case, there may be used, as the input unit 14, a known sight line analyzing system and a known image analyzing system, for example. Then, when a driver has performed a predetermined action or the like, the input unit 14 may output the first signal to the electronic apparatus 12 corresponding to such an action.

Returning to FIG. 1, the description is continued.

The following will describe the in-vehicle device 10. The in-vehicle device 10 includes a communication unit 16, a storage unit 18, a head up display (HUD) device 20, and a control unit 22. The communication unit 16, the storage unit 18, the HUD device 20, and the control unit 22 are communicably connected to one another by a bus or the like.

The communication unit 16 performs communication with each of the electronic apparatuses 12 and the input unit 14 through a network, a bus, or the like.

The storage unit 18 stores various kinds of data. The storage unit 18 is, for example, a random-access memory (RAM), a semiconductor memory element such as a flash memory, a hard disk, an optical disk, and the like. Note that the storage unit 18 may be a storage medium. Concretely, the storage medium may store or temporarily store computer programs or various kinds of information downloaded through a local area network (LAN), the Internet, or the like. Moreover, the storage unit 18 may be formed by a plurality of storage media.

Note that at least one of the storage unit 18 and the control unit 22 may be provided outside the in-vehicle device 10. Furthermore, at least one of the storage unit 18 and the control unit 22 may be provided outside the vehicle 2.

The HUD device 20 is a device that projects image light of images on the front windshield of the vehicle 2.

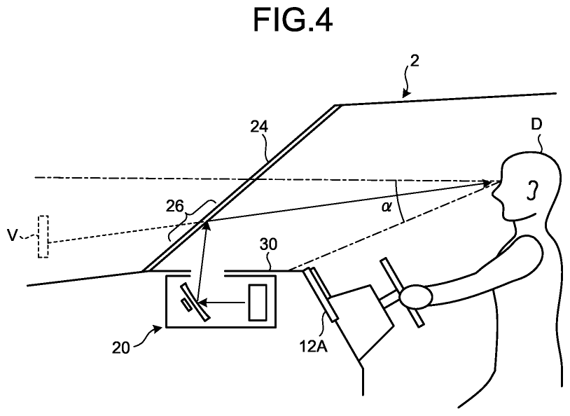

FIG. 4 is a schematic view illustrating a use example of the HUD device 20. The HUD device 20 is provided at a dashboard 30 of the vehicle 2, for example. By the control of the control unit 22 described later, the HUD device 20 projects image light of images on a display area 26 of a front windshield 24. The image light is reflected on the front windshield 24, and directed to a driver D of the vehicle 2, for example. With this, the driver D visually recognizes the image shown by image light projected on the front windshield 24 as a virtual image V displayed to be superimposed on a real landscape in the visually recognition area of the driver D. That is, the HUD device 20 allows the driver D to visually recognize the image shown by image light as a virtual image.

Note that the display area 26 may be a partial area of the front visual field of the driver D in a predetermined depression angle α. The depression angle α may be within a view angle of the front visual field of the driver D of the vehicle 2. Moreover, the display area 26 may be an area predetermined in a part of the front visual field of the driver D of the vehicle 2. The embodiment exemplifies a case where the display area 26 is an area on the front windshield 24 of the vehicle 2, the area being set in front of a driver's seat of the driver D. That is, the display area 26 is a head up display area set on the front windshield 24, for example. The head up display area is an area on the front windshield 24 set in the visually recognition area of the driver D. In other words, the head up display area is an area on which images are projected by the HUD device 20.

The embodiment exemplifies a case where the area on the front windshield 24 is the display area 26. Note that if the vehicle 2 is provided with a combiner, the HUD device 20 may project image light on the combiner. In this case, the display area 26 may be an area on the combiner arranged in the front visual field of the driver D.

Here, the electronic apparatuses 12 are provided at various positions in the vehicle 2. Moreover, the display units 13B of the electronic apparatuses 12 are also provided at various positions in the vehicle 2.

The following will describe it using FIG. 3. For example, as illustrated in FIG. 3, the display unit 13B of the vehicle state display device 12A is provided in a meter in the vehicle interior of the vehicle 2. The display provided in a meter may be referred to as a multi-information display.

Moreover, the display unit 13B of the electronic rear-view mirror 12B is provided at a rear-view mirror position in the vehicle interior of the vehicle 2. The drive recorder 12C, the multimedia 12D with phone function, and the air conditioner 12E are arranged in the dashboard 30 of the vehicle 2, for example. A center display 28, for example, is used as the display units 13B of these drive recorder 12C, multimedia 12D with phone function, and air conditioner 12E.

In the conventional technique, when the driver D as a user desires to confirm or switch the state of the electronic apparatus 12, the driver D needs to perform an operation while gazing at the electronic apparatus 12 to be operated or confirmed or the display unit 13B of such an electronic apparatus 12. Furthermore, these operations may be performed while the vehicle 2 is traveling. Therefore, in the conventional technique, the sight line of the driver D may deviate from the forward direction or traveling direction of the vehicle 2 to be focused on the electronic apparatus 12 to be operated or confirmed, thus hindering driving.

Returning to FIG. 1, the description is continued. Then, the in-vehicle system 1 of the embodiment prevents a gaze at a target apparatus.

Concretely, in the embodiment, the control unit 13A of the electronic apparatus 12 receives the first signal from the input unit 14. That is, the control unit 13A of the electronic apparatus 12 as a target apparatus receives the first signal. As described above, the first signal is at least one of a target apparatus state switching instruction signal and a target apparatus state confirming instruction signal. The control unit 13A of the electronic apparatus 12 having received the first signal transmits the second signal including identification information of the electronic apparatus 12 and information related to a display element of the electronic apparatus 12, to the in-vehicle device 10.

The display element is a display element for receiving a selection related to switching of the state of a target apparatus. The definition of the “state of a target apparatus” has been described above, and thus the description thereof is omitted here.

Note that the display element may be a display element for receiving an instruction related to confirmation of the state of a target apparatus. Moreover, the display element may be a display element for receiving a selection of a function of a target apparatus.

The display element is represented by characters, icons, or the like indicating setting contents or display contents of a target apparatus, functions or setting values of a target apparatus, and the like.

To be more specific, in a case where the target apparatus is the vehicle state display device 12A, the display element is characters or icons related to the state of the vehicle 2, for example. Concretely, in this case, the display element is characters or icons related to a speed, average fuel consumption, instantaneous fuel consumption, vehicle maintenance, an integrated value of traveling distances, a travelable distance, an energy remaining amount, the on/off state of a drive support function, and the like.

In a case where the target apparatus is the electronic rear-view mirror 12B, the display element is, for example, characters or icons indicating each of a wide angle mode and a glare proof mode, characters or icons indicating the on/off state of these functions, icons for receiving switching of on/off of these functions, and the like.

In a case where the target apparatus is the drive recorder 12C, the display element is, for example, characters or icons indicating each of an event recording mode and a continuous recording mode, characters or icons indicating the on/off state of these functions, and the like.

Moreover, in a case where the target apparatus is the multimedia 12D with phone function, the display element is characters or icons indicating each of an outgoing phone call function, an incoming/outgoing phone call history management function, a phone book management function, and a favorite management function, for example.

In a case where the target apparatus is the air conditioner 12E, the display element is, for example, characters or icons indicating a heating function, a cooling function, a dehumidification function, and the like, characters or icons indicating the on/off state of these functions, characters or icons indicating setting contents of these functions, and the like. The setting contents of these functions are, for example, setting values of temperature, an air amount, and the like.

In a case where the target apparatus is a radio, the display element is, for example, an icon for receiving a selection of a frequency, characters indicating a frequency, icons for switching frequency modulation (FM)/amplitude modulation (AM), and the like.

The control unit 13A of the electronic apparatus 12 having received the first signal specifies display elements related to the state of the electronic apparatus 12. To be more specific, the control unit 13A specifies display elements such as icons for receiving a selection of current setting contents of the electronic apparatus 12, current setting values of the electronic apparatus 12, display contents displayed on the display unit 13B of the electronic apparatus 12, and functions of the electronic apparatus 12. Then, the control unit 13A of the electronic apparatus 12 transmits the second signal including the specified display elements and the identification information of the electronic apparatus 12 to the in-vehicle device 10.

The control unit 22 of the in-vehicle device 10 controls the HUD device 20 in accordance with the second signal received from the electronic apparatus 12.

The control unit 22 includes a reception unit 22A and a display control unit 22B.

The entire reception unit 22A and display control unit 22B or a part thereof may be achieved by controlling a processing device such as the CPU 11A (see FIG. 2), for example, to execute a computer program, that is, by software, achieved by hardware such as an integrated circuit (IC), or achieved by both software and hardware.

The reception unit 22A receives the second signal from the electronic apparatus 12. As described above, upon receiving the first signal from the input unit 14, the electronic apparatus 12 transmits the second signal related to the first signal to the in-vehicle device 10. Thus, the reception unit 22A of the in-vehicle device 10 receives the second signal related to the first signal from the target apparatus when an input of the first signal to the target apparatus has been received.

Note that the reception unit 22A of the in-vehicle device 10 may receive the first signal from the input unit 14. In this case, the reception unit 22A may transmit a second signal transmission request to the electronic apparatus 12 specified by the received first signal. Then, the control unit 13A of the electronic apparatus 12 having received the transmission request may generate the second signal and transmit it to the in-vehicle device 10. With such processing, the reception unit 22A of the in-vehicle device 10 may receive the second signal from the target apparatus.

When the reception unit 22A has received the second signal, the display control unit 22B displays a first image on the display area 26. The first image is an image including one or more display elements related to the state of a target apparatus.

The display control unit 22B displays, on the display area 26, the first image including a display element included in the second signal received from the target apparatus. The display of an image on the display area 26 by the display control unit 22B indicates a control on the HUD device 20 to display an image. Concretely, the display control unit 22B outputs image signals of a display image including the first image to the HUD device 20. The HUD device 20 projects image light of the received image signals on the display area 26 of the front windshield 24. In this manner, the display image including the first image is displayed on the display area 26 of the front windshield 24.

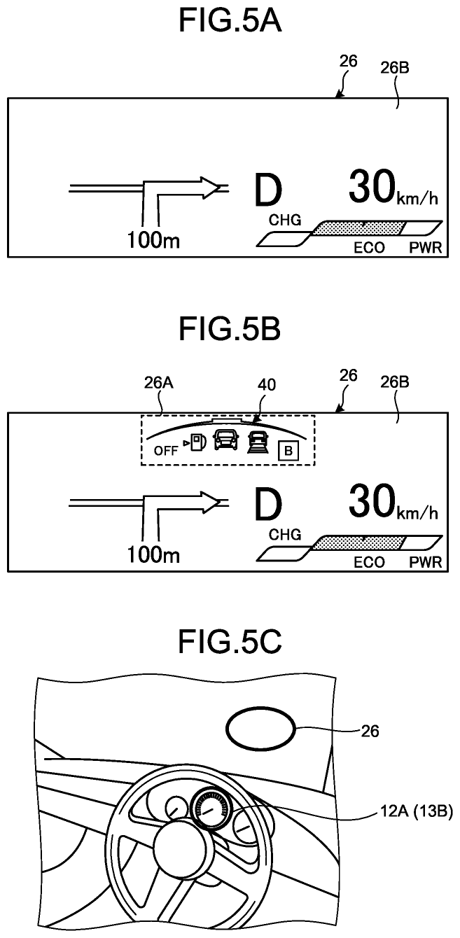

FIG. 5A to FIG. 5C are explanatory diagrams of examples of the display image displayed on the display area 26. As an example, FIG. 5A to FIG. 5C illustrate the case where the target apparatus is the vehicle state display device 12A.

FIG. 5A is a schematic view illustrating an example of a second image 26B. The second image 26B is an image displayed on the display area 26 when the in-vehicle device 10 is in the normal state that is a state before reception of the second signal. The second image 26B may be an image including predetermined elements. FIG. 5A illustrates, as an example, a case where the second image 26B includes the information indicating the current traveling state of the vehicle 2 and the information indicating a part of a scheduled traveling route.

For example, the display control unit 22B displays, in the normal state, the second image 26B on the display area 26. Thus, in the normal state, the second image 26B is displayed on the display area 26 of the front windshield 24.

FIG. 5B is a schematic view illustrating an example of the display image including a first image 26A. When the second signal has been received, the display control unit 22B displays the first image 26A on the display area 26. The display control unit 22B displays, on the display area 26, the first image 26A including display elements 40 included in the second signal. For example, the first image 26A includes the display elements 40 for selecting a trip meter, a drive support function, vehicle maintenance, an energy remaining amount, and display off in this order from the right in the drawing.

Note that the second signal is not limited to the form including the display element 40. For example, the second signal may be a signal including element identification information of the display element 40, instead of the display element 40. In this case, the storage unit 18 preliminarily stores the display element 40 corresponding to the element identification information, for example. The display control unit 22B may specify, from the storage unit 18, the display element 40 corresponding to the element identification information included in the second signal, and use it for the first image 26A.

As illustrated in FIG. 5B, the display control unit 22B displays a superimposed image of the second image 26B and the first image 26A on the display area 26, for example. To be more specific, the display control unit 22B displays a superimposed image formed by superimposing the first image 26A on the second image 26B on the display area 26.

The driver D operates the input unit 14 to select the desired display element 40 among a plurality of display elements 40 displayed on the display area 26. For example, the user operates the switch 14B or 14C to select the desired display element 40. The control unit 13A of the electronic apparatus 12 having received operation signals of the switch 14B or the switch 14C performs processing corresponding to the operation signals. For example, the electronic apparatus 12 performs a control for turning on a drive support function or the like.

Therefore, as illustrated in FIG. 5C, the driver D is able to perform an operation of switching or confirming the state of the target apparatus while visually recognizing the display area 26 on the front windshield 24 without gazing at the vehicle state display device 12A. That is, the driver D is able to make an operation instruction to the target electronic apparatus 12 while keeping visually recognizing the forward direction of the vehicle 2.

Note that upon determining the completion of an operation on a target apparatus, the display control unit 22B may hide the first image 26A. In this case, the display control unit 22B determines the completion of an operation on the target apparatus when the display element 40 has been selected by an operation instruction at the input unit 14 by a user, for example. Then, when the completion of an operation has been determined, the display control unit 22B may cancel the display of the first image 26A and display a display screen including the second image 26B on the display area 26. Moreover, the display control unit 22B may determine the completion of an operation when the state without any operation has continued for a predetermined period of time or longer, for example. The predetermined period of time may be five seconds, for example, without limiting thereto. In this case, a display image of the second image 26B illustrated in FIG. 5A is displayed on the display area 26, for example.

In this manner, upon determining the completion of an operation on a target apparatus, the display control unit 22B hides the first image 26A, and displays, on the display area 26, the second image 26B that is an image in the normal state. Therefore, the display control unit 22B is able to utilize the display area 26 as effectively as possible.

Note that the display control unit 22B may display a reduced image of the second image 26B, and the first image 26A on the display area 26.

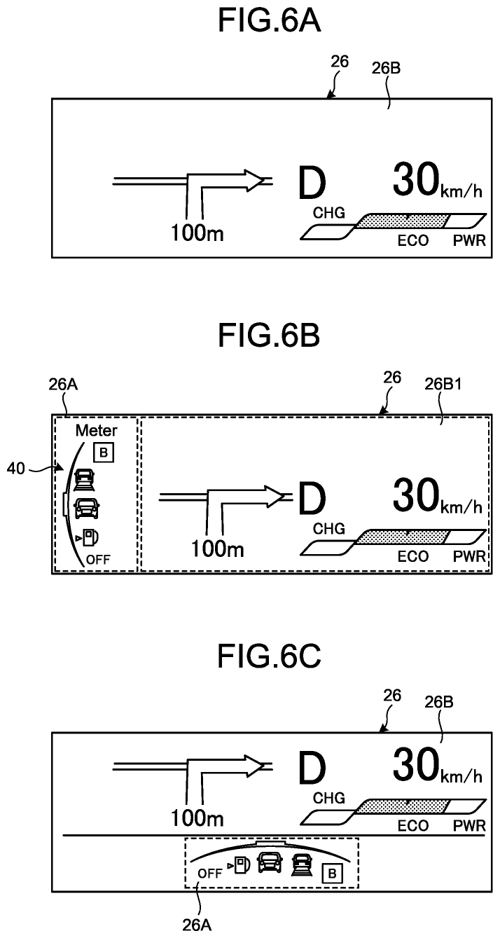

FIG. 6A to FIG. 6C are explanatory diagrams of examples of the display image displayed on the display area 26.

As illustrated in FIG. 6A, the display control unit 22B displays, in the normal state, the second image 26B on the display area 26, for example. Then, as illustrated in FIG. 6B, the display control unit 22B displays, when the second signal has been received, a display image including a reduced image 26B1 of the second image 26B, and the first image 26A on the display area 26. The reduced image 26B1 may be the second image 26B with reduced display magnification. For example, the reduced image 26B1 may be the second image 26B compressed in a horizontal direction or a vertical direction for display. Alternatively, the reduced image 26B1 may be the second image 26B with the same display magnification but a segment thereof. In the following, a case where a part of the second image 26B is segmented to obtain the reduced image 26B1, may also be referred to as “the second image 26B is reduced”.

Then, upon determining the completion of an operation on a target apparatus, the display control unit 22B may hide the first image 26A and display, on the display area 26, the second image 26B the reduction state of which has been cancelled. In this case, the display image illustrated in FIG. 6A is displayed on the display area 26.

Note that the display control unit 22B may reduce the second image 26B upon determining that the area of the first image 26A to be displayed interferes with display elements of the second image 26B. Then, the display control unit 22B may display a display image including the reduced image of the second image 26B, and the first image 26A on the display area 26.

Moreover, the display control unit 22B may display the first image 26A on an area corresponding to the installation direction of a target apparatus in the display area 26.

In this case, when the second signal has been received, the display control unit 22B identifies an installation direction, relative to the display area 26, of the electronic apparatus 12 identified by identification information included in the second signal. For example, the storage unit 18 preliminarily associates and stores the identification information of the electronic apparatus 12 and the installation direction of the electronic apparatus 12 relative to the display area 26. The display control unit 22B may read out, from the storage unit 18, an installation direction corresponding to the identification information included in the received second signal to identify the installation direction.

Then, the display control unit 22B may generate a display image where the first image 26A is arranged in the identified installation direction in the display area 26, and display the display image on the display area 26.

As illustrated in FIG. 6C, in this case, the first image 26A including the display elements 40 related to the vehicle state display device 12A is displayed on an area corresponding to the installation direction of the vehicle state display device 12A in the display area 26. In the embodiment, the vehicle state display device 12A is provided in the lower side of the display area 26. Thus, the first image 26A including the display elements 40 related to the vehicle state display device 12A is displayed on an area in the lower side of the display area 26.

Similarly, it is assumed that the target apparatus is the multimedia 12D with phone function. In this case, the display control unit 22B displays the first image 26A on an area corresponding to the installation direction of the multimedia 12D with phone function in the display area 26. Concretely, the first image 26A of the multimedia 12D with phone function is displayed on the left side area of the display area 26 in FIG. 6C.

In this manner, the display control unit 22B allows the driver D to intuitively recognize which electronic apparatus 12 the first image 26A is related to.

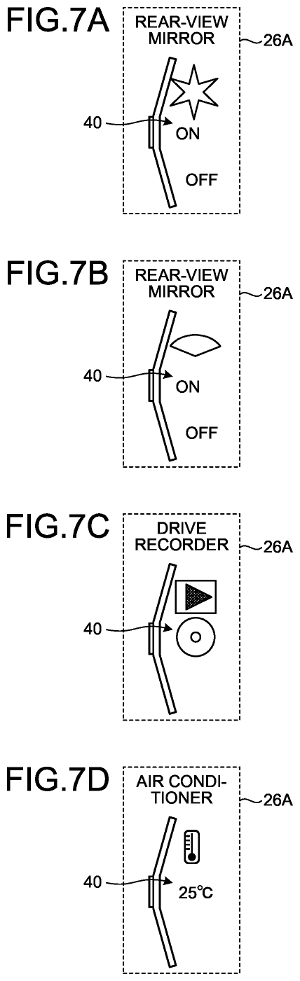

FIG. 7A to FIG. 7D are schematic views illustrating examples of the first image 26A.

FIG. 7A and FIG. 7B illustrate, as an example, a case where the target apparatus is the electronic rear-view mirror 12B.

In this case, as illustrated in FIG. 7A, the first image 26A includes the display elements 40 such as characters or icons indicating a glare proof mode, and icons for receiving switching of on/off of the glare proof mode, for example. Moreover, as illustrated in FIG. 7B, the first image 26A includes the display elements 40 such as characters or icons indicating a wide angle mode, and icons for receiving switching of on/off of the wide angle mode, for example.

FIG. 7C illustrates, as an example, a case where the target apparatus is the drive recorder 12C.

In this case, the first image 26A includes, as the display element 40, icons for receiving switching to each of an event recording mode and a continuous recording mode, for example.

FIG. 7D illustrates, as an example, a case where the target apparatus is the air conditioner 12E.

In this case, the first image 26A includes the display element 40 such as icons for receiving a current setting temperature, and a change of a temperature, for example.

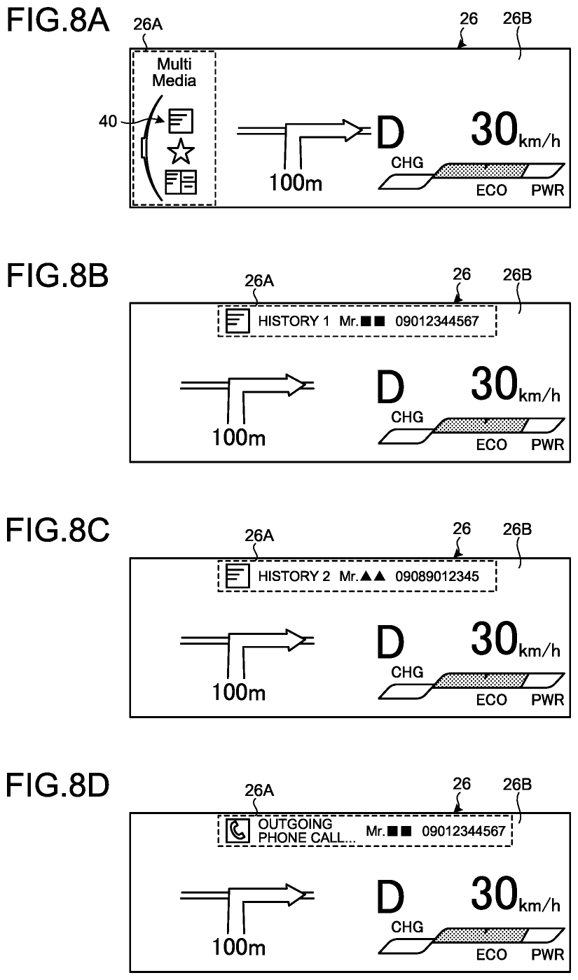

FIG. 8A to FIG. 8D are explanatory diagrams of examples of the display image displayed on the display area 26. FIG. 8A to FIG. 8D illustrate, as an example, a case where the target apparatus is the multimedia 12D with phone function.

As illustrated in FIG. 8A, for example, the display control unit 22B displays, on the display area 26, the first image 26A including icons indicating an incoming/outgoing phone call history management function, a favorite management function, a phone book management function, and the like, as the display elements 40.

It is assumed that the display element 40 of the incoming/outgoing phone call history management function has been selected by an operation instruction at the switch 14B by a user. In this case, as illustrated in FIG. 8B and FIG. 8C, the display control unit 22B sequentially displays, on the display area 26, phone information included in the incoming/outgoing phone call history as the first image 26A, every time the operation instruction at the switch 14B is received. Then, for example, when an outgoing phone call is instructed by an operation instruction at the switch 14C by the user, the control unit 13A of the multimedia 12D with phone function starts processing of outgoing phone call to a phone number included in the selected phone information. Here, as illustrated in FIG. 8D, the display control unit 22B displays, on the display area 26, the first image 26A including the display element 40 indicating that the phone number is being called, for example.

In this manner, the driver D is able to instruct the multimedia 12D with phone function to perform various operation instructions such as switching or execution of functions while visually recognizing the front visual field.

The following will describe information processing performed by the electronic apparatus 12.

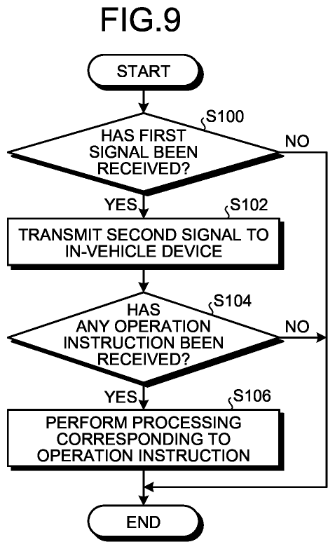

FIG. 9 is a flowchart illustrating an example of information processing performed by the electronic apparatus 12 according to the embodiment.

The control unit 13A of the vehicle state display device 12A determines whether the first signal has been received from the input unit 14 (Step S100).

If the determination is negative at Step S100 (No at Step S100), the routine is ended. If the determination is positive at Step S100 (Yes at Step S100), the routine proceeds to Step S102.

At Step S102, the control unit 13A of the vehicle state display device 12A generates the second signal and transmits it to the in-vehicle device 10.

Next, the control unit 13A of the vehicle state display device 12A determines whether any operation instruction has been received from the input unit 14 or the input unit 13C (Step S104). If the determination is negative at Step S104 (No at Step S104), the routine is ended. If the determination is positive at Step S104 (Yes at Step S104), the routine proceeds to Step S106.

At Step S106, the control unit 13A of the vehicle state display device 12A performs processing corresponding to the operation instruction received at Step S104 (Step S106). Then, the routine is ended.

The following will describe information processing performed by the in-vehicle device 10.

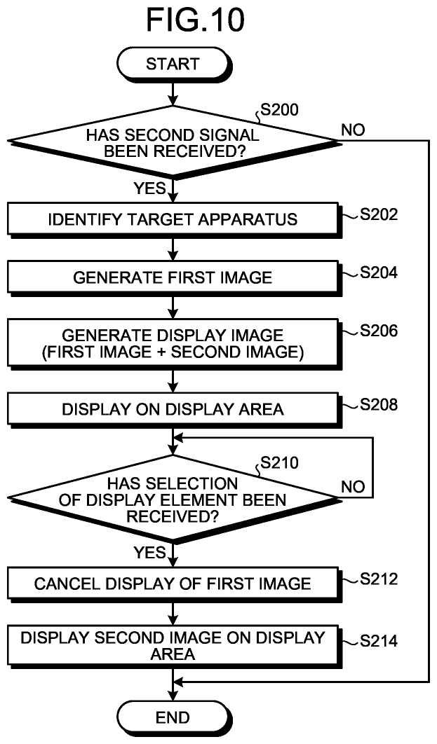

FIG. 10 is a flowchart illustrating an example of information processing performed by the in-vehicle device 10 according to the embodiment.

The reception unit 22A determines whether the second signal has been received from the electronic apparatus 12 that is a target apparatus (Step S200). If the determination is negative at Step S200 (No at Step S200), the routine is ended. If the determination is positive at Step S200 (Yes at Step S200), the routine proceeds to Step S202.

At Step S202, the display control unit 22B identifies the electronic apparatus 12 corresponding to the identification information included in the second signal received at Step S200, thereby identifying the electronic apparatus 12 that is a target apparatus (Step S202).

Next, the display control unit 22B generates the first image 26A including the display element 40 included in the second signal received at Step S200 (Step S204). Next, the display control unit 22B generates a display image (Step S206). At Step S206, the display control unit 22B generates the display image including the second image 26B and the first image 26A.

Then, the display control unit 22B displays the display image generated at Step S206 on the display area 26 (Step S208).

Next, the display control unit 22B determines whether a selection of the display element 40 included in the first image 26A displayed at Step S208 has been received (Step S210). The display control unit 22B determines whether operation signals have been received from the switch 14B or the switch 14C by an operation instruction at these switches by a user, thereby performing determination at Step S210.

The display control unit 22B repeats negative determination (No at Step S210) until the determination becomes positive (Yes at Step S210). When the display control unit 22B has performed positive determination (Yes at Step S210), the routine proceeds to Step S212.

At Step S212, the display of the first image 26A displayed on the display area 26 is cancelled (Step S212), and the second image 26B is displayed on the display area 26 (Step S214). Then, the routine is ended.

Note that at Step S210, instead of determination of whether a selection of the display element 40 has been received, there may be determined completion of an operation on a target apparatus. Then, when the completion of an operation has been determined, the routine may proceed to Step S212. Moreover, in a case where the display element 40 is arranged in a hierarchy, the display control unit 22B may display a different display element 40 of a different hierarchy every time the selection of the display element 40 is received. Then, when the execution of any display element 40 has been instructed, the positive determination may be made at Step S210.

As described above, the in-vehicle device 10 of the embodiment includes the reception unit 22A and the display control unit 22B. The reception unit 22A receives the second signal related to the first signal, which is transmitted from a target apparatus when an input of the first signal to the target apparatus has been received. When the second signal has been received, the display control unit 22B displays the first image 26A including one or more display elements 40 related to the state of the target apparatus on the display area 26 predetermined in a part of the front visual field of the driver D of the vehicle 2.

In this manner, when the second signal has been received, the display control unit 22B of the in-vehicle device 10 of the embodiment displays the first image including the display element 40 related to the target apparatus, on the display area 26 in the front visual field of the driver D. The second signal is a signal received from a target apparatus when an input of the first signal to the target apparatus has been received.

Thus, with the in-vehicle device 10 of the embodiment, the driver D is able to visually recognize the display element 40 related to the state of a target apparatus while visually recognizing the front visual field. That is, in the in-vehicle device 10 of the embodiment, the driver D is able to make an operation instruction such as switching or confirmation of the state to a target apparatus while visually recognizing the front visual field without gazing at the target apparatus that is the electronic apparatus 12 to be operated or confirmed.

Therefore, the in-vehicle device 10 of the embodiment is able to prevent a gaze at a target apparatus.

Moreover, the driver D operates the input unit 14 while visually recognizing the display area 26 in the front visual field, thereby switching the state of the target apparatus, for example, while visually recognizing the front visual field. That is, the in-vehicle device 10 allows the driver D to perform a pseudo-operation on the electronic apparatus 12 on the display area 26 in the front visual field. Therefore, the in-vehicle device 10 of the embodiment is able to provide environments enabling safe driving in addition to the above-described effects.

Moreover, with the in-vehicle device 10 of the embodiment, the driver D may visually recognize the forward direction when switching the state of a target apparatus, and visually recognize the target apparatus after switching. Thus, the in-vehicle device 10 of the embodiment is able to reduce time in which the sight line of the driver D deviates from the front visual field.

Moreover, the in-vehicle device 10 of the embodiment is able to prevent the driver D from gazing at a target apparatus even while the vehicle 2 is traveling. Thus, the in-vehicle device 10 of the embodiment is able to improve the usability in addition to the above-described effects.

Furthermore, in the in-vehicle system 1 of the embodiment, when a target apparatus has received an input of the first signal, the in-vehicle device 10 displays, on the display area 26, the first image 26A including the display element 40 related to the target apparatus using the second signal received from the target apparatus. Thus, in the in-vehicle system 1 of the embodiment, it is possible to achieve apparatus cooperation between the electronic apparatus 12 and the in-vehicle device 10. This allows processing such as unified and cooperated display between the electronic apparatus 12 and the in-vehicle device 10.

The in-vehicle device, the in-vehicle device control method, and the in-vehicle system according to the disclosure are able to prevent a gaze at a target apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An in-vehicle device comprising:
a memory; and
a hardware processor coupled to the memory, wherein
the hardware processor is configured to:
receive a second signal transmitted from a target apparatus when an input of a first signal to the target apparatus has been received, the second signal being related to the first signal; and
display, when the second signal has been received, a first image including one or more display elements related to a state of the target apparatus on a display area predetermined in a part of a front visual field of a driver of a vehicle.

2. The in-vehicle device according to 1, wherein the first signal is at least one of a switching instruction signal regarding the state of the target apparatus and a confirming instruction signal regarding the state of the target apparatus.

3. The in-vehicle device according to claim 1, wherein the second signal includes identification information of the target apparatus and information related to the one or more display elements of the target apparatus.

4. The in-vehicle device according to claim 1, wherein the hardware processor is configured to display, on the display area, a superimposed image of a second image predetermined to be displayed on the display area and the first image.

5. The in-vehicle device according to claim 1, wherein the hardware processor is configured to display, on the display area, a reduced image of a second image predetermined to be displayed on the display area, and the first image.

6. The in-vehicle device according to claim 5, wherein the hardware processor is configured to, when completion of an operation on the target apparatus has been determined, hide the first image and display, on the display area, the second image having its reduction state cancelled.

7. The in-vehicle device according to claim 1, wherein the hardware processor is configured to display the first image on an area corresponding to an installation direction of the target apparatus in the display area.

8. The in-vehicle device according to claim 1, wherein the one or more display elements comprise a display element for receiving a selection related to switching of a state of the target apparatus.

9. The in-vehicle device according to claim 1, wherein the target apparatus is an electronic apparatus communicably connected to the in-vehicle device, and is at least one of a vehicle state display device, an electronic rear-view mirror, and a drive recorder.

10. The in-vehicle device according to claim 1, wherein the display area is a partial area of a front visual field of a driver of a vehicle within a predetermined depression angle of the driver.

11. The in-vehicle device according to claim 1, wherein the display area is an area on a front windshield of the vehicle, the area being set in front of a driver's seat.

12. The in-vehicle device according to claim 11, wherein the display area is a head up display area set on the front windshield.

13. An in-vehicle device control method comprising:
receiving a second signal transmitted from a target apparatus when an input of the first signal to the target apparatus has been received, the second signal being related to the first signal; and
displaying, when the second signal has been received, a first image including one or more display elements related to a state of the target apparatus on a display area predetermined in a part of a front visual field of a driver of a vehicle.

14. An in-vehicle system comprising:
an in-vehicle device; and
one or more electronic apparatuses communicably connected to the in-vehicle device, wherein
the in-vehicle device includes:
a memory; and
a hardware processor coupled to the memory, and
the hardware processor is configured to:
receive a second signal transmitted from a target apparatus that is a targeted electronic apparatus of the one or more electronic apparatuses, when an input of a first signal to the target apparatus has been received, the second signal being related to the first signal; and
display, when the second signal has been received, a first image including one or more display elements related to a state of the target apparatus on a display area predetermined in a part of a front visual field of a driver of a vehicle.
